(19) United States
(12) Patent Application Publication
(10) Pub. No.: US 2018/0278190 A1
(43) Pub. Date: Sep. 27, 2018

(54) CONTROLLING A MOTORIZED WHEEL

(71) Applicant: Inboard Technology, Inc., Soquel, CA (US)

(72) Inventor: Theodore Cerboneschi, San Francisco, CA (US)

(21) Appl. No.: 15/927,632

(22) Filed: Mar. 21, 2018

Related U.S. Application Data
(60) Provisional application No. 62/474,567, filed on Mar. 21, 2017.

(51) Int. Cl. H02P 23/00; A63C 17/12; A63C 17/01; H02P 6/04; H02P 6/16

(52) U.S. Cl. CPC H02P 23/0077; A63C 17/12; A63C 17/015; H02K 11/215; H02P 6/16; A63C 2203/12; A63C 2203/24; H02P 6/04

(57) ABSTRACT

An electrically powered vehicle having software to facilitate variable control of a motorized wheel. The software can modify the manner in which electricity is provided to phases of a motor of the motorized wheel. In some aspects, the modification of electricity provided to the phases can adjust a speed and/or a torque of the motor of the motorized wheel.

### CROSS-REFERENCE TO RELATED APPLICATIONS

This application claims priority to and the benefit of U.S. Provisional Patent Application No. 62/474,567, filed on Mar. 21, 2017, entitled “Controlling a Motorized Wheel,” the disclosure of which is incorporated herein in its entirety for all purposes.

### TECHNICAL FIELD

The subject matter described herein relates to controlling a motorized wheel.

### BACKGROUND

Skateboards typically include an elongated board, sometimes referred to as a deck, having an upper surface and a lower surface. The upper surface typically support the feet of a rider of the skateboard and the lower surface typically have two trucks attached to the deck disposed toward either end of the deck. The upper surface may support the rider who is sitting on the skateboard. The trucks typically include one or more axles. Wheels, typically one on either side of the truck, attach to the axles. The trucks typically provide several degrees of freedom to the wheels relative to the skateboard deck, allowing the wheels to roll over uneven ground and facilitate turning of the skateboard by the rider.

Skateboards typically require the rider to provide the propelling force to move the skateboard, usually by the rider having one foot on the deck of the skateboard and another pushing off from the ground.

Some skateboards have been developed that include a power source. The power source may be a gasoline powered engine. The power source may be an electrically-powered motor. When the power source is an electrically-powered motor, controlling the power and torque output of the electrically-powered motor can be important.

### SUMMARY

A system and method is provided for controlling the power output and/or torque of a motorized wheel at different speeds.

In one aspect, a powered skateboard may include one or more electrical motors configured to provide motive force for the electrically powered vehicle. The one or more electric motors can include a plurality of phases. The powered skateboard may further include a battery configured to provide electrical power to the one or more electric motors. The powered skateboard may further include a controller configured to use software to control the one or more electric motors.

In another aspect, a method of powering an electrically powered vehicle is provided. The method may include storing, in memory, software for controlling one or more electric motors of a powered vehicle, the one or more electric motors comprising a plurality of phases. The method may further include controlling, in response to executing the software on a controller of the powered vehicle, a delivery of electricity to the one or more electric motors.

The method of powering an electrically powered vehicle may optionally include delivering electricity to the plurality of phases to cause a ninety-degree angle on the magnetic field generated by the one or more electric motors. The method of powering an electrically powered vehicle may optionally include detecting motion of the electrically powered vehicle; and adjusting, based on the detected motion, a speed of the one or more electric motors.

In some variations one or more of the following features can optionally be included in any feasible combination. The software can be configured to control delivery of electrical power to one or more phases of the plurality of phases of the one or more electric motors. The controller can be configured to deliver electricity to the plurality of phases to cause a ninety-degree angle on the magnetic field generated by the electric motor. The electrically powered vehicle can further include a memory configured to store the software. The electrically powered vehicle can further include a receiver configured to receive, over a wireless data connection, updated software to store in the memory, and wherein the controller is further configured to use the updated software to control the one or more electric motors. The software can facilitate variable control of the one or more electric motors. The one or more electric motors can further include a stator, the stator comprising a plurality of stator teeth. The electrically powered vehicle can further include one or more sensors configured to determine, based on a voltage of the one or more sensors, positions of the plurality of stator teeth associated with different phases of the plurality of phases. The controller can be further configured to advance a phase at which electricity is delivered to the one or more electric motors to modify an angle of torque relative to the motor. An amount of phase advance can be based on a speed of the one or more electric motors, a position of a throttle on the controller, an amount of load on the one or more electric motors, a target duty cycle, and/or a target phase angle.

The details of one or more variations of the subject matter described herein are set forth in the accompanying drawings and the description below. Other features and advantages of the subject matter described herein will be apparent from the description and drawings, and from the claims. Certain features of the currently disclosed subject matter are described for illustrative purposes only and it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 is a side view of various elements of the skateboard, having one or more features consistent with implementations of the current subject matter;

FIG. 2 is an exploded view of an example of a powered wheel and a portion of the skateboard, having one or more elements consistent with the current subject matter;

FIG. 3A is an exploded view of a powered wheel, having one or more features consistent with implementations of the current subject matter;

FIG. 3B is an exploded view of an electric motor disposed on an axle of a skateboard truck, the electric motor having one or more elements consistent with the current subject matter;

FIG. 3C is an end view of a powered wheel 116 disposed on the axle 304 of a skateboard truck 302;

FIG. 4A is an exploded perspective view of a powered wheel, having one or more features consistent with implementations of the current subject matter;

FIG. 4B is an exploded side view of the powered wheel;

FIG. 5 is an exploded view illustration of a commercial embodiment of a powered wheel, having one or more features consistent with the current subject matter;

FIG. 6 is a schematic view of an electric circuit for powering an electric motor, having one or more elements consistent with the current subject matter;

FIG. 7 is a diagram of various elements of a powered skateboard, having one or more features consistent with implementations of the current subject matter; and

FIG. 8 is a schematic diagram of a control system for a powered skateboard having one or more features consistent with the present description.

When practical, similar reference numbers denote similar structures, features, or elements.

### DETAILED DESCRIPTION

A powered skateboard can include an electric motor. The electric motor can be a hub motor disposed within the wheel of a powered skateboard. The electric motor may be configured to efficiently operate at different speeds by changing the manner in which electricity is delivered to different phases of the electric motor. For example, when the operator of the powered skateboard initially starts the powered skateboard, electricity may be delivered to the phases of the electric motor in such a manner to facilitate acceleration, or an increased amount of torque. As another example, when the operator of the powered skateboard maintains a desired speed, electricity can be delivered to the phases of the electric motor in such a manner as to maintain the speed of the powered skateboard. In some examples, this may manifest in the electric hub motor producing an increased power output.

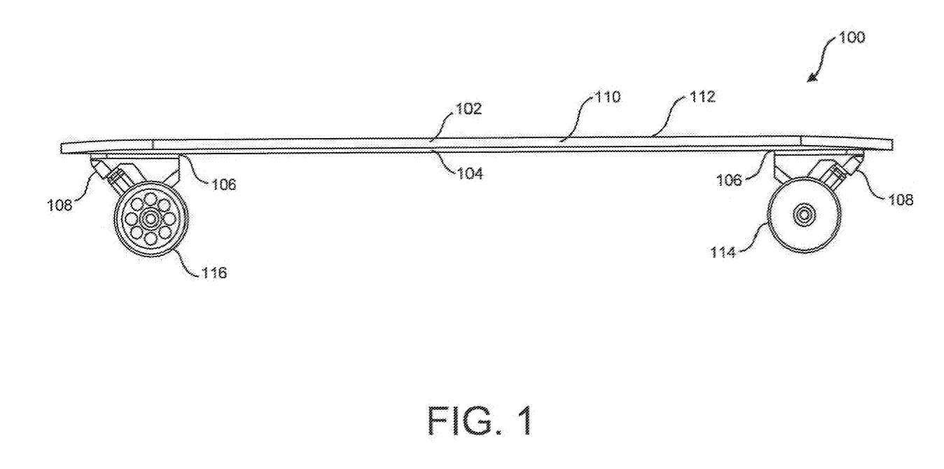

This description, at times, refers to an electrically powered skateboard to demonstrate the application of the invention. This is for ease of explanation only and is intended to be limiting. An electrically powered skateboard is one example of an application of the present description. The presently described regenerative braking system can be applied to any electrically powered vehicle. FIG. 1 is a side view of various elements of the skateboard 100, having one or more features consistent with implementations of the current subject matter. The skateboard 100 can comprise a skateboard deck 102. The skateboard deck 102 may comprise a bottom portion 104. The bottom portion 104 may have truck-mounting portions 106 configured to facilitate engagement with one or more skateboard trucks 108. The skateboard deck 102 may comprise a top portion 110. The top portion 110 may have an upper surface 112. The upper surface 112 may be configured to support a rider of the skateboard 100.

The one or more skateboard trucks 108 can be configured to support one or more wheels 114 and 116. In some variations, the skateboard trucks 108 may be configured to support unpowered wheels 114 and/or powered wheels 116. The powered wheels 116 can be disposed on both front and rear trucks 108 of the skateboard 100, or can be disposed on just one of the trucks 108. The powered wheels 116 can be disposed on one side or on both sides of the truck(s) 108. The powered wheels 116 can be disposed on the truck 108 that is located on the rear portion of the skateboard 100.

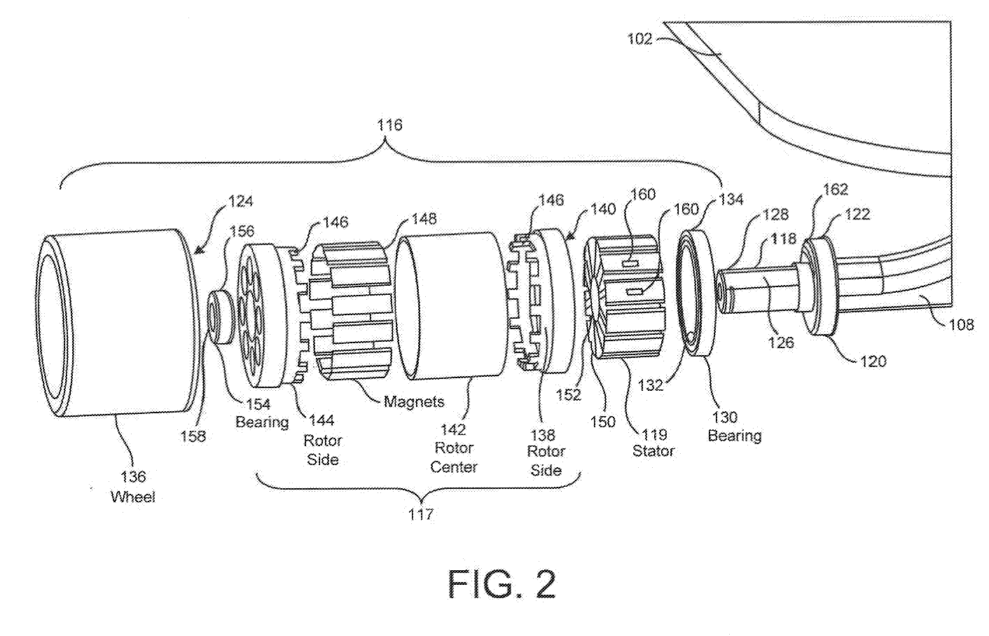

FIG. 2 is a schematic illustration of an example of a powered wheel 116 and a portion of the skateboard 100, having one or more elements consistent with the current subject matter. The powered wheel 116 can include an electric motor disposed within the powered wheel 116. The electric motor can include a rotor 117 and a stator 119. The rotor 117 and the stator 119 can be engaged with the axle 118 of the skateboard truck 108. The electric motor can be a three-phase electric motor. The electric motor can be a five-phase electric motor. The electric motor can be an n-phase electric motor. The powered wheel 116 can be attached to a truck 108 on a truck axle 118. The truck axle 118 can include a flange 120. The flange 120 can be configured to prohibit inward movement of the powered wheel 116. The flange can include an outer rim 122. The outer rim 122 can be configured to support an internal surface 124 of the powered wheel 116. The outer rim 122 providing support for the powered wheel 116, reducing strain on the internal components of the powered wheel 116 and the axle 118. The axle 118 can include an engagement portion 126. The engagement portion 126 can be configured to provide a surface on which the force of the powered wheel 116 can work against. Without having an engagement portion 126, the powered wheel 116 would spin about the axle 118 and provide little motive force. The axle 118 can include a retaining slot 128, configured to facilitate retaining the powered wheel 116 on the axle 118.

The powered wheel 116 can include a first bearing 130. The first bearing 130 can be configured to engage with the flange 120. The first bearing 130 can have an inner race 132 configured to engage with the surface 122 of the flange 120. The first bearing 130 can have an outer race 134 configured to engage with the inner surface 124 of a wheel 134. The inner race 132 and outer race 134 of the first bearing 130 can be rotationally engaged. Rotational capabilities of the first bearing 130 can be facilitated through the use of ball bearings, greased channels, oil channels and/or other friction reducing mechanisms between the inner race 132 and the outer race 134. In this manner, the first bearing 130 can be configured to facilitate rotation of the powered wheel 116 about the axle 118.

In some variations, the first bearing 130 can be disposed within a first rotor side 138. The first rotor side 138 can include an inner surface 140. The first rotor side 138 can comprise a center bore adapted to fixedly attached to the outer race 134 of the first bearing 130. The first rotor side 138 can be a solid rotor. The first rotor side 138 can further comprise hollows bored into the inside perimeter. In some variations, the first rotor side 138 can include between 6 and 20 hollows bored into the inside perimeter. The hollows can be configured to provide airflow, reduced weight, and structural integrity. The hollows can be covered to prevent ingress of foreign bodies into the rotor. The first rotor side 138 can be visible when the powered wheel 116 is assembled. The second rotor side 144 can include a single large bore in its center adapted to fixedly attach to the outer race 156 of the second bearing 154 disposed in the center of the second rotor side 144.

The outer race 134 of the first bearing 130 can be configured to engage with the inner surface 140 of the first rotor side 138. In some variations, the first bearing 130 can have an inner diameter of between 5 mm and 10 mm. The first bearing 130 can have an outer diameter between 15 mm and 30 mm. The first bearing 130 can have a thickness between 5 mm and 10 mm. One of ordinary skill in the art will understand and appreciate that the size of the bearing is proportionate to the size of the powered wheel 116. Consequently, the presently described subject matter contemplates different sizes of first bearing 130, just as it contemplates different sizes of powered wheels 116.

The powered wheel 116 can include a rotor can 142. The rotor can 142 can comprise a material having one or more magnetic properties. The rotor can 142 can be comprised of a magnetically permeable material. The rotor can 142 can be configured to cause all or most of the magnetic field to be contained within the rotor 117. The rotor can 142 can comprise a single piece of steel alloy. The rotor can 142 can be configured to engage with at least a portion of a first rotor side 138 and a second rotor side 144. The first rotor side 138 and the second rotor side 144 can comprise one or more teeth 146. The teeth 146 can be configured to receive and support magnets 148. The teeth 146 can be configured to support the magnets 148 at specific locations. Magnets 148 can be permanent magnets. The first rotor side 138 and the second rotor side 144 can include flanges between 1 mm and 2 mm in length extending inward. In the preferred embodiment, the first rotor side 138 and the second rotor side 144 can be made of aluminum. In an alternative embodiment, the first rotor side 138 and the second rotor side 144 can be identical.

The magnets 148 can be arranged into a magnet array. Between 10 and 28 rectangular magnets 148 can be positioned within the rotor can 142. The magnets 148 can be neodymium magnets. The magnets 148 can be disposed in a circular array forming a ring. The magnets 148 can be attached to the inside of the rotor can 142 by an adhesive such as epoxy. The outer ends of the magnets 148 can lock into the teeth, or pockets 146 of the first rotor side 138 and the second rotor side 144.

The stator 119 can be configured to be disposed within the rotor 117. The stator 119 can be formed of a permanent magnet. The stator 119 can be formed of an electromagnet. The stator 119 can be formed of laminated steel. The stator 119 can comprise stator slots 150 and stator teeth 152. The stator slots 150 and stator teeth 152 can be disposed about the periphery of the stator 119. In some variations, the stator 119 can comprise a plurality of steel sheets stacked together in a circular array. The steel sheets can be fixedly attached to the axle 118. The stacks of steel sheets can form stator teeth 152. The stator slots 150 and stator teeth 152 can be configured to carry electric wire forming windings (not shown). The windings can be three-phase, five-phase, or n-phase windings. The windings can be wound copper wire. The windings can be a solid metal. The windings can be some other suitable material. The windings can be configured to carry current. A controller can be configured to cause the current to pass through successive phases of the electric motor to cause the rotor 117 to rotate about the stator 119.

A second bearing 154 can be configured to be disposed between the axle 118 and the inner surface of the stator 117. The second bearing 154 is rotationally attached to the axle 118 of the skateboard truck 108 on its inner race 158 and allows the powered wheel 116 to spin on the axle 118 by reducing rotational friction. The second bearing 154 is positioned within the inside of the stator 119 and allows the stator to spin around the outer race 156 of the second bearing 154. One of ordinary skill in the art will appreciate and understand that the size of the second bearing 154 depends on the size of the powered wheel 116 and/or the axle 118. The present disclosure contemplates different sizes of powered wheels 116 and axles 118. Consequently, the present disclosure contemplates different sizes of second bearing 154. The first bearing 130 and the second bearing 154 can be configured to facilitate rotation of the rotor 117 about the stator 119 that is fixedly engaged to the axle 118. The stator 119 can be fixedly engaged to the axle 118 by having an internal surface 152 with a shape that compliments the shape of the axle 118. The stator 119 can be held in place by a stator pin, mechanical locking groove, a circlip, or the like. The shape of the internal surface 152 can include a flat portion that compliments with the flat portion 126 of the axle 118.

The powered wheel 116 can comprise a wheel 136 configured to fit over the rotor 117. The wheel 136 can be glued or molded around the rotor 117. The wheel 136 can include an internal structure facilitating the engagement of the wheel 136 with the rotor 142. The wheel 126 can be press-fit onto the rotor 142. In some variations, the wheel 136 may be thermo cooled. The wheel 136 can serve as a tire for the powered wheel 116. The wheel 136 can be configured to mechanically engage with the rotor 117. The wheel 136 can be composed of polyurethane. The wheel 136 can be composed of rubber or any similar compound or material used for similar purposes.

In some variations, the powered wheel 116 can include wheel sizes ranging from 25 mm to 100 mm in diameter and from 25 mm to 100 mm in width.

One or more Hall effect sensors 160 can be positioned between the teeth 152 of the stator 119. The Hall effect sensor(s) 160 can be positioned at specific locations. The Hall effect sensor(s) 160 can be attached between the stator teeth of the stator 119 with adhesive. In some variations, the Hall effect sensor(s) 160 can be attached to a printed circuit board disposed between the teeth of stator teeth. The Hall effect sensor(s) 160 can be attached to the stator 119 mechanically. In some variations, the teeth 152 of the stator 119 can include pockets configured to receive the Hall effect sensor(s) 160. The Hall effect sensor(s) 160 can be configured to facilitate a smooth start of the electric motor from a stationary position.

The Hall effect sensor(s) 160 can function by operating as a transducer and changing the amount of voltage it releases in relation to a magnetic field to achieve different mechanical effects. The Hall effect sensor(s) 160 can be configured to provide information about the position of the rotor to a controller. With this information, the controller can more accurately control the flow of current to the various phases of the electric motor.

Wiring to connect the windings about the stator teeth 152 to a power source and/or a controller can be disposed along the flat portion 126 of the axle 118. The wiring can be run through an aperture 162 through the flange 120 of the axle 118.

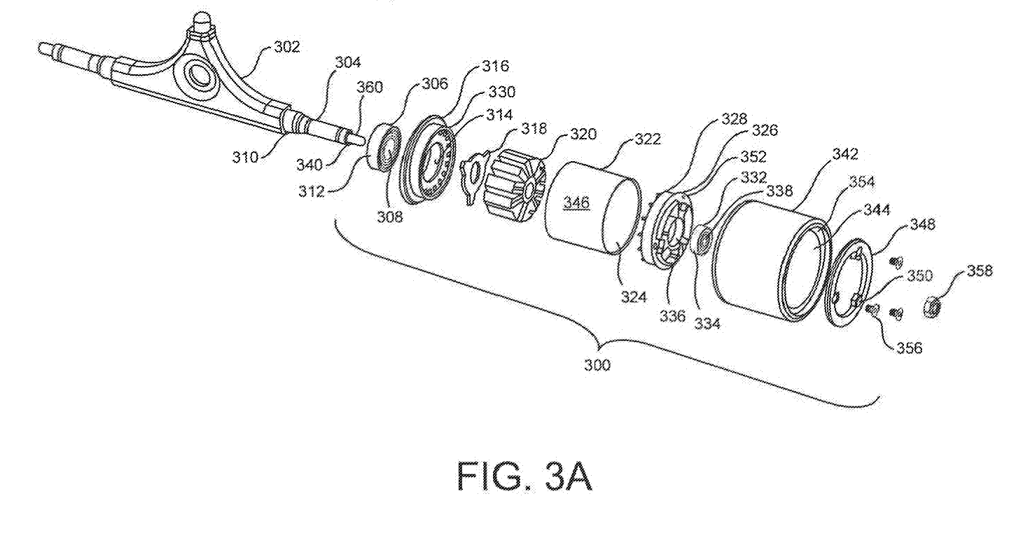

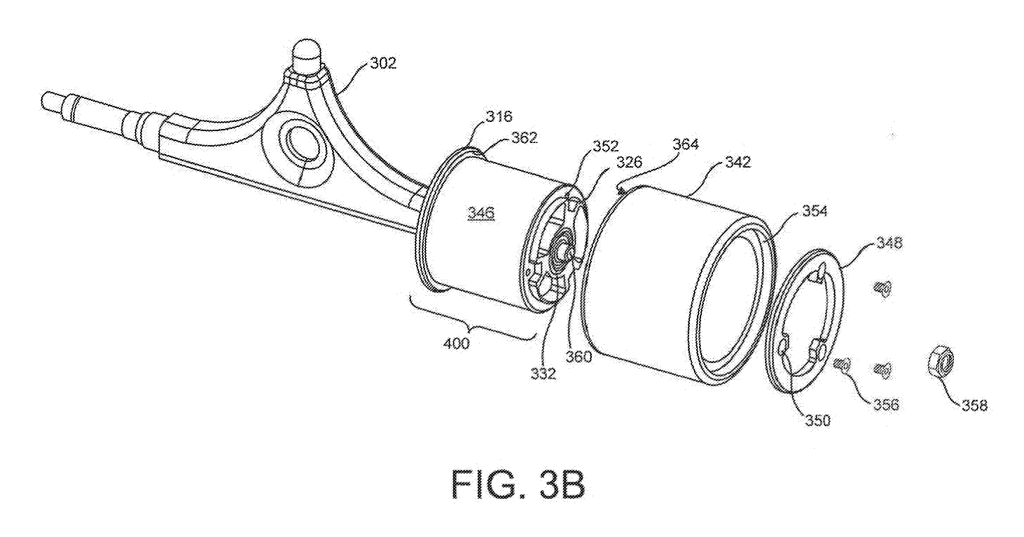

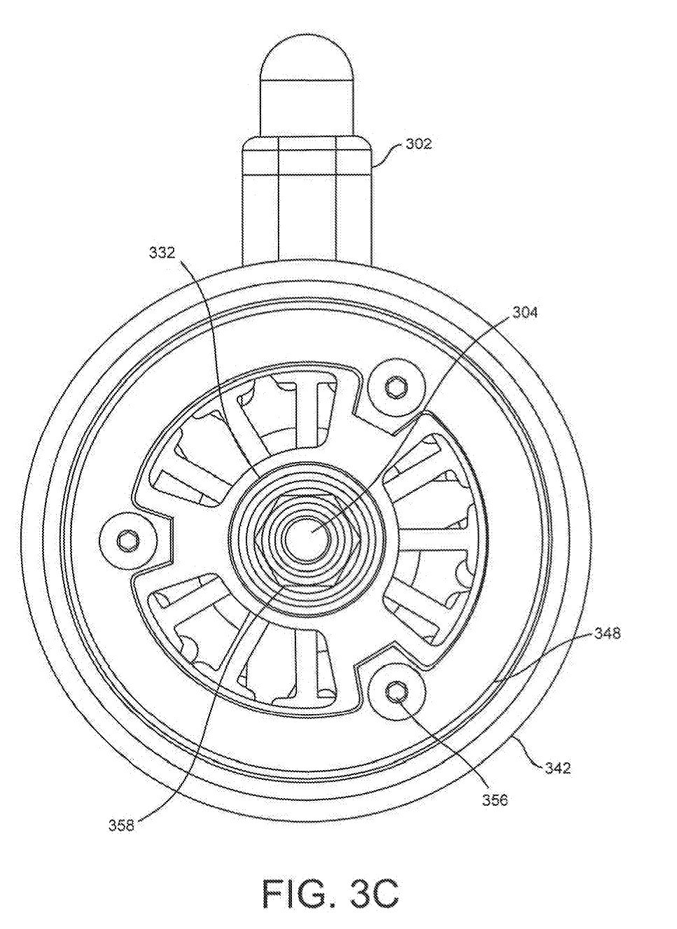

FIG. 3A is an exploded view of a powered wheel 300, having one or more features consistent with implementations of the current subject matter. The powered wheel 300 can be configured to attach to any type of skateboard truck. The powered wheel 300 can be configured to attach to a specialized skateboard truck. The skateboard truck 302 can include a skateboard axle 304. The powered wheel 300 can comprise a bearing 306. The bearing 306 can be similar to bearing 130 illustrated in FIG. 2. An inner race 308 of the bearing 306 can be configured to engage with at least a portion 310 of the axle 304 of the skateboard truck 302. An outer race 312 of the bearing 306 can be configured to engage with an inner surface 314 of an inner motor support 316. Then inner motor support 316 can be a rotor side.

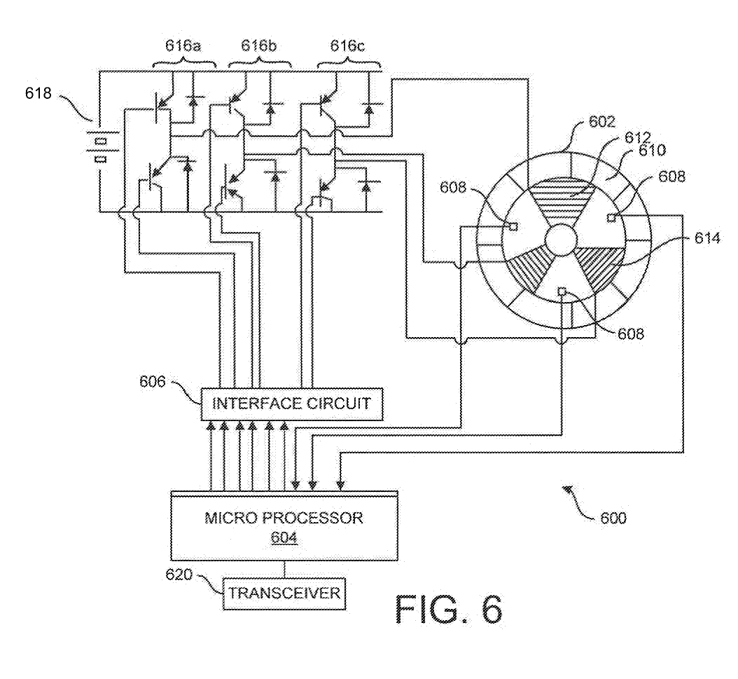

The powered wheel 300 can include a position encoder 318. The position encoder 318 can be disposed between the inner motor support 316 and a stator 320. The stator 320 can be similar to stator 119 illustrated in FIG. 2. The position encoder 318 can be a mechanical encoder, an optical encoder, a magnetic encoder, a capacitive encoder and/or another type of encoder. The position encoder 318 can be configured to convert the angular position of motion of the powered wheel 300 relative to the axle 304 to an analog or a digital code. The analog or digital code can be used by a microprocessor (such as microprocessor 604 of FIG. 6) to determine the orientation of the stator 320 relative to the known position of the position encoder 318. The position encoder 318 can include a Hall effect sensor (such as Hall effect sensor 160). The position encoder 318 can include a printed circuit board having one or more electrical components included thereon.

The powered wheel 300 can include a rotor can 322. The rotor can 322 can include a plurality of magnets attached to the inner surface 324 of the rotor can 322. The rotor can 322 can be a magnetic flux ring. The magnetic flux ring can be configured to provide the same or similar functionality to having a plurality of magnets attached to the inner surface 324 of the rotor can 322.

The powered wheel 300 can include an outer motor support 326. The outer motor support 326 can be a rotor side. The outer motor support 326 can include a flange 328 adapted to engage with an inner surface 324 of the rotor can 322. The inner motor support 316 can include a flange 330 adapted to engage with the inner surface 324 of the rotor can 322 opposite the outer motor support 326.

The powered wheel 300 can include an outer bearing 332. The outer bearing 332 can include an outer race 334 and an inner race 338. The outer race 334 can be configured to engage with an inner surface 336 of the outer motor support 326. The inner race 338 of the outer bearing 332 can be configured to engage with at least a portion 340 of the axle 304 of the skateboard truck 302. The inner bearing 306 and the outer bearing 332 can be configured to facilitate rotation of the inner motor support 316, stator 320, rotor can 322 and outer motor support 326 about the axle 304.

The powered wheel 300 can include a wheel 342. The wheel 342 can be comprised of plastic. Plastic suitable for the wheel 342 can include a polyurethane. The material suitable for the wheel 342 can be thermosetting material, a thermoplastic material, or a combination thereof. The material suitable for the wheel 342 can be a compound material. Additive materials can be added to the compound used to fabricate the wheel 342 to provide different properties. Different heat treatments and molding processes can be employed when making the wheel 342 to provide wheels 342 with different properties.

An inner surface 344 of the wheel 342 can be configured to engage with an outer surface 346 of the rotor can 322. In some variations, the outer surface 346 of the rotor can 322 and the inner surface 344 of the wheel 342 can include complimentary engagement portions. The engagement portions prohibiting the rotor can 322 from rotating within the wheel 342 and to facilitate transfer of torque from the rotor can 322 to the wheel 342.

A retaining ring 348 can be used to hold the wheel 342 onto the motor. The retaining ring 348 can include one or more fastener holes 350. The one or more fastener holes 350 can be aligned with one or more fastener holes 352 on the outer motor support 326. The retaining ring 348 can be configured to fit within a recess 354 of the wheel 342. Fasteners 356 can be used to secure the retaining ring 348 to the outer motor support 326.

A retaining bolt 358 can be configured to screw onto a thread portion 360 of the axle 304. The retaining bolt 358 can be configured to retain the outer bearing 332 on the axle 304.

FIG. 3B is an exploded view of an electric motor 400 disposed on an axle of a skateboard truck 302, the electric motor 400 having one or more elements consistent with the current subject matter. The inner motor support 316 can include a flange 362 configured to engage with an inner side 364 of the wheel 342. In some variations, an electric motor 400 can be provided that is preassembled as the electric motor 400. The electric motor can be disposed onto the axle of the skateboard truck 302. A wheel 342 can be positioned over the motor 400 to engage with the outer surface 346 of the rotor can 322. The retaining ring 348 can be configured to retain the wheel 342 onto the electric motor 400. The retaining nut 358 can be configured to retain the electric motor 400 on the axle of the skateboard truck 302.

FIG. 3C is an end view of a powered wheel 116 disposed on the axle 304 of a skateboard truck 302.

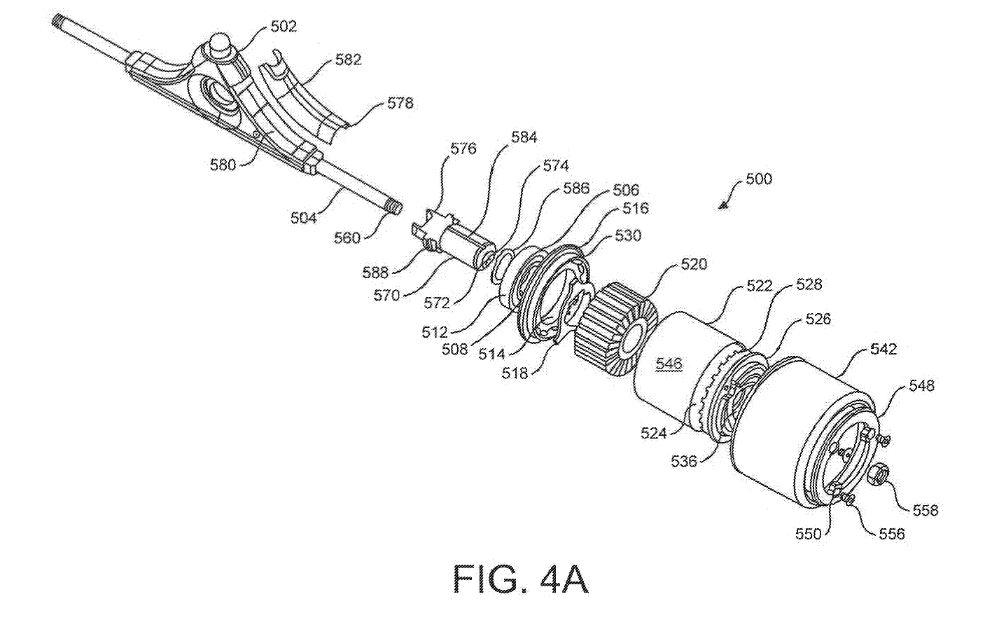

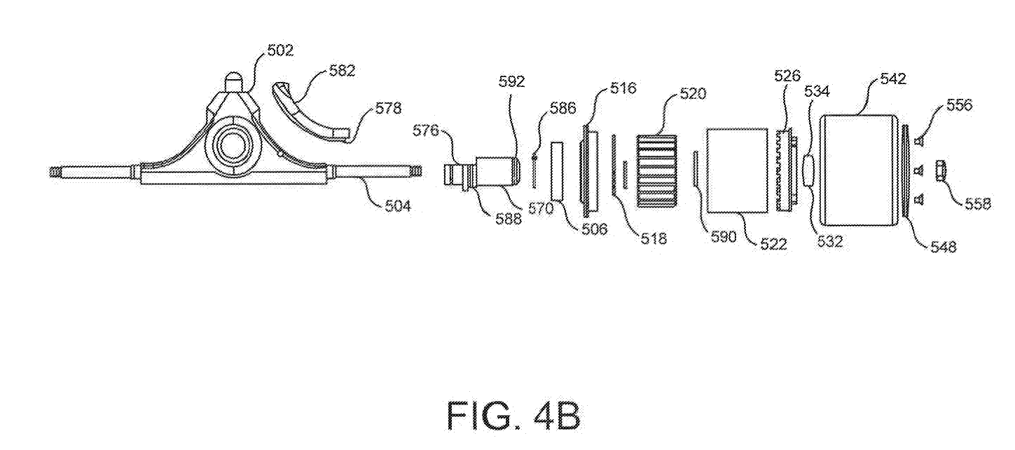

FIG. 4A is an exploded perspective view of a powered wheel 500, having one or more features consistent with implementations of the current subject matter. FIG. 4B is an exploded side view of the powered wheel 500. The powered wheel 500 is similar in some aspects to the powered wheel 300 illustrated in FIG. 3A. The powered wheel 500 can be configured to attach to a skateboard truck 502. The skateboard truck 502 can be a generic skateboard truck. The skateboard truck 502 can be a specialty skateboard truck configured to engage with the powered wheel 500. The skateboard truck 502 can include a skateboard axle 504.

The powered wheel can include a hub 570. The hub 570 can include a hollow through-portion 572. The hollow through-portion 572 can be configured to receive the axle 504 of the truck 502. The hub 570 can be have a length to facilitate a threaded portion 560 of the axle 504 to extend beyond the end 574 of the hub 570. The hub 570 can include a rotational hindering portion 576. The rotational hindering portion 576 can include a flattened portion. The rotational hindering portion 576 of the hub 570 can be configured to engage with a rotational hindering portion 578 engaged with the truck 502. The rotational hindering portion 576 of the hub 570 and the rotational hindering portion 578 of the truck 502 can have complementary shapes facilitating engagement of the two rotational hindering portions.

The truck 502 can include a conduit 580. The conduit can be configured to house electrical wiring. The electrical wiring can be disposed between a power source for the powered wheel 500 and the powered wheel 500. The conduit 580 can include a conduit cover 582. In some variations, the conduit cover 582 can include the rotational hindering portion 578 of the truck 502.

The hub 570 can include a channel 584. The channel 584 can be configured to house electrical wiring to at least the stator 520 of the powered wheel 500.

The powered wheel 500 can comprise a bearing 506. The bearing 506 can be similar to bearing 306 illustrated in FIG. 3A. An inner race 508 of the bearing 506 can be configured to engage with at least a portion of the hub 570. An outer race 512 of the bearing 506 can be configured to engage with an inner surface 514 of an inner motor support 516. Then inner motor support 516 can be similar to the inner motor support 316 in FIG. 3A. A clip 586 can be employed to secure the bearing 506 into the inner motor support 516. The clip 586 can be configured to engage with a lateral groove 588 of the hub 570. The lateral groove 588 can circumvent the hub 570. The clip 586, engaged with the lateral groove 588 can prevent components of the powered wheel 500 from moving too far inward toward the truck 502.

The powered wheel can include a position encoder 518. The position encoder 518 can be similar to position encoder 318 of FIG. 3A. The position encoder 518 can include a printed circuit board (PCB). The PCB can include one or more electrical components. The one or more electrical components can include at least one Hall effect sensor. The position encoder 518 can be disposed adjacent the stator 520. The stator 520 can be similar to stator 320 illustrated in FIG. 3A.

A rotor can 522 can be provided to surround the stator 520. The rotor can 522 can include a plurality of magnets attached to the inner surface 524 of the rotor can 522. The rotor can 522 can be a magnetic flux ring. The magnetic flux ring can be configured to provide the same or similar functionality to having a plurality of magnets attached to the inner surface 524 of the rotor can 522.

The powered wheel 500 can include an outer motor support 526. The outer motor support 526 can be similar to the outer motor support 326 of FIG. 3A. The outer motor support 526 can include a flange 528 adapted to engage with an inner surface 524 of the rotor can 522. The inner motor support 516 can include a flange 530 adapted to engage with the inner surface 524 of the rotor can 522 opposite the outer motor support 526.

The powered wheel 500 can include an outer bearing 532. The outer bearing 532 can include an outer race 534. The outer race 534 can be configured to engage with an inner surface 536 of the outer motor support 526. The inner race (not shown) of the outer bearing 532 can be configured to engage with at least a portion of the hub 570. The inner bearing 506 and the outer bearing 532 can be configured to facilitate rotation of the inner motor support 516, stator 520, rotor can 522 and outer motor support 526 about the hub 570.

The powered wheel 500 can include an outer clip 590. The outer clip 590 can be configured to inhibit the components of the powered wheel 500 from moving outward. The outer clip 590 can be configured to retain the components of the powered wheel 500 on the hub 570. The outer clip 590 can be configured to engage with an outer lateral groove 592. The outer lateral groove 592 can circumvent the hub 570.

The powered wheel 500 can include a wheel 542. The wheel 542 can be similar to wheel 342 illustrated in FIG. 3A.

The powered wheel 500 can include a retaining ring 548. The retaining ring 548 can be configured to hold the wheel 542 onto the motor. The retaining ring 548 can include one or more fastener holes 550. The one or more fastener holes 550 can be aligned with one or more fastener holes on the outer motor support 526. The retaining ring 548 can be configured to fit within a recess of the wheel 542. Fasteners 556 can be used to secure the retaining ring 548 to the outer motor support 526.

The powered wheel 500 can include a retaining bolt 558. The retaining bolt 558 can be configured to screw onto a threaded portion 560 of the axle 504. The retaining bolt 558 can be configured to retain the outer bearing 532 on the axle 504. In some variations, the outer clip 590 can be integrated with the retaining bolt 558, the retaining ring 548, a combination thereof, or the like.

In some variations, the hub 570 may include an axle binding device. The axle binding device configured to bind the hub 570 onto the axle 504. The retaining bolt 558 can be configured to retain the powered wheel 500 onto the hub 570.

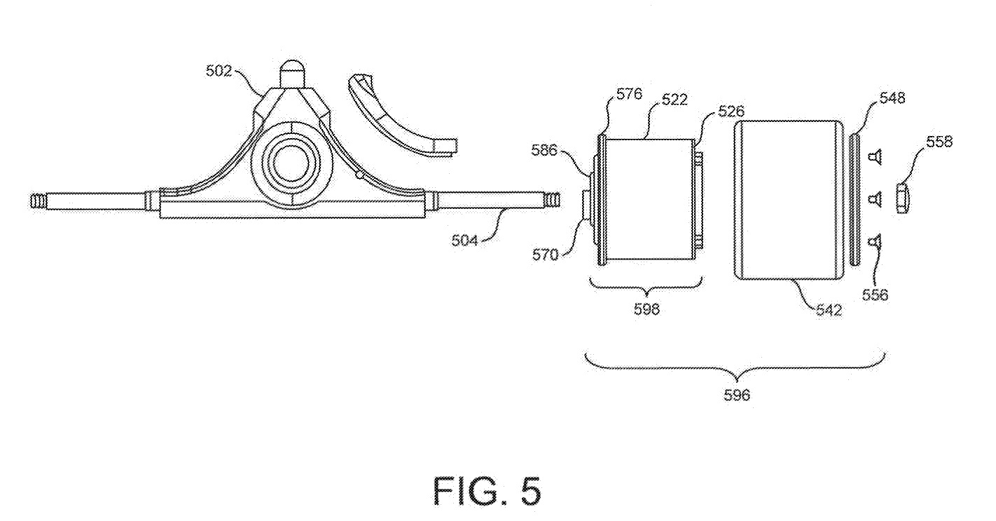

FIG. 5 is an exploded view of a commercial embodiment of a powered wheel 500, having one or more features consistent with the current subject matter. The powered wheel 500 may be supplied as a powered wheel unit 596. The powered wheel 500 may be supplied with the motor unit 598, the wheel 542, the retaining ring 548, fasteners 556 and retaining bolt 558 fully assembled. In some variations, the wheel 542 may be supplied separately, or replacement wheels 542 may be supplied. The retaining ring 548 and fasteners 556 can be configured to facilitate easy replacement of the wheel 542.

While the presently described powered wheels 100, 300 and 500 are illustrated and discussed in relation to being provided for a skateboard, the present disclosure contemplates that the powered wheels can be provided for any item having an axle. For example, the presently described powered wheels can be provided for luggage, bicycles, shopping carts, wheel chairs, and the like. The relative size of the components of the presently described powered wheels can be modified to fit the intended purpose of the powered wheel and the medium on which the powered wheel is intended to be disposed.

FIG. 6 is a schematic view of an electric circuit 600 for powering an electric motor 602, having one or more elements consistent with the current subject matter. The electric motor 602 illustrated in FIG. 6 is a representation only. The configuration of the stator and the rotor are not intended to be limiting. The electric motor 602 may be a three-phase motor, as shown.

The electric motor 602 may be controlled by one or more microprocessors 604. The microprocessor(s) may be configured to control the electric motor 602 through an interference circuit 606. The electric motor 602 may include one or more Hall sensors 608. The Hall sensor(s) 608 can be configured to vary its output voltage based on the magnetic field experienced by the Hall sensor(s) 608. As the rotor 610 of the electric motor rotates about the stator 612, the magnetic field at the Hall sensor(s) 608 will change. The change in the magnetic field at the Hall sensor(s) 608 can be measured such that the output voltage of the Hall sensor(s) 308 can be mapped to the position of the stator teeth 614. Consequently, the positions of the stator teeth associated with different phases of an n-phase electric motor 602 can be known based on the output voltage of the Hall sensor(s) 608. The microprocessor 604 can be configured to receive an indication of the output voltage of the Hall sensor(s) 608 and control the current provided to the different phases of the n-phase motor 602.

Each phase of the n-phase motor can be associated with a rectifier 616a, 616b and 616c. While semiconductor rectifiers are illustrated, the current subject matter contemplates any type of rectifier, including vacuum tube diodes, mercury-arc valves, copper and selenium oxide rectifiers, semiconductor diodes, silicon-controlled rectifiers and other silicon-based semiconductor switches.

The electric motor 602 can be powered by a power supply 618. The power supply 618 can also be configured to provide power to the microprocessor(s) 604. The microprocessor(s) 604 can be in direct or indirect electronic communication with a transceiver 620. The transceiver 620 can be configured to transmit and/or receive signals from one or more input devices.

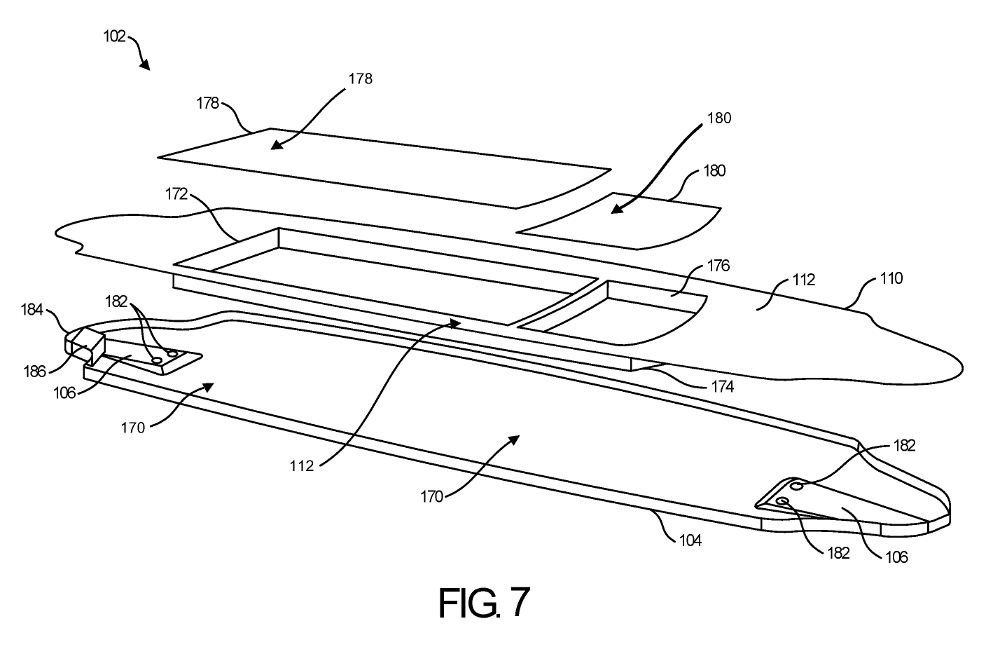

FIG. 7 is a diagram of various elements of the skateboard deck 102, having one or more features consistent with implementations of the current subject matter. The skateboard deck 102 may comprise a bottom portion 104. The bottom portion 104 may have truck mounting portions 106 configured to facilitate engagement with one or more skateboard trucks 108 (as shown in FIG. 1).

The skateboard truck(s) 108 can be made from aluminum. The skateboard truck(s) 108 can comprise an axle 118 that extends horizontally from one wheel to the other wheel. The skateboard truck(s) 108 can comprise multiple axles that extend outward from the skateboard truck(s) 108 on either side of the skateboard truck(s) 108. Each skateboard truck can be configured to have each wheel positioned between about 120 mm and about 180 mm apart. The skateboard truck(s) 108 can be mechanically attached to the skateboard by bolts.

The skateboard deck 102 may comprise a top portion 110. The top portion 110 may have an upper surface 112. The upper surface 112 may be configured to support a rider of the powered skateboard 100. The skateboard deck 102 may have a cavity 170. The cavity 170 may be disposed between the bottom portion 104 and the top portion 110 of the skateboard deck 102. The cavity 170 may be adapted to store one or more components of the powered skateboard 100.

The top portion 110 of the skateboard deck 102 may include an aperture 172. The aperture 172 may be configured to facilitate access to the cavity 170 between the top portion 110 and the bottom portion 104 of the skateboard deck 102.

The bottom portion 104 of the skateboard deck 102 may include support structures. The top portion 110 of the skateboard 102 may include support structures 174. The support structures may be configured to provide support for the top portion 110 of the skateboard deck 102 to facilitate the top portion 110 to support a rider of the powered skateboard 100. The support structure can be configured as a honeycomb structure. The support structure can include one or more lateral and/or longitudinal support structures.

In some variations of the current subject matter, the top portion 110 of the skateboard deck 102 may comprise multiple apertures 172, 176. One aperture 172 may be configured to facilitate access to components of the powered skateboard 100 that may be regularly removed. Such regularly removed components may include a fuel source for the powered skateboard 100 and/or a container for the fuel source of the powered skateboard 100. Another aperture 176 may be configured to facilitate access to components of the powered skateboard 100 that are not regularly removed. Such components not regularly removed may be control systems for controlling the powered skateboard.

The components may include a transceiver 620 (as shown in FIG. 6) configured to communicate with one or more mobile devices. The transceiver 620 may be one or more of a Wi-Fi transceiver, a Bluetooth transceiver, a Near-Field-Communication transceiver, a sub-gigahertz transceiver, and/or any other wireless communication transceiver. The transceiver 620 may be in electronic communication with the control system for the powered skateboard. The control system may be configured to modify one or more parameters of the powered skateboard.

A lid 178 can be provided for the aperture 172. The lid 178 can be configured to cover the aperture 172 and provide support to a rider of the powered skateboard 100. The lid 178 can be configured to be screwed in place to cover the aperture 172 and provide support to the rider. The lid 178 can be configured to attach to the top portion 110 of the skateboard deck 102 via a hinge, a latch, a connector, or any other connection mechanism. The top portion 110 of the skateboard deck 102 can comprise slots to engage with the lid 178, such that the lid 178 can slide into the slots and cover the aperture 172 and support the rider. The lid 178 may be removable engaged with the top portion 110 of the skateboard deck 102.

Having the lid 178 removably engaged with the top portion 110 of the skateboard deck 102 can facilitate a user of the powered skateboard to access one or more components of the powered skateboard stored in the cavity 170. For example, the powered skateboard may be electrically powered. The cavity 170 can be configured to store one or more battery packs to provide electrical power to one or more electric motors of the powered skateboard. Having the lid 178 removably engaged with the top portion 110 of the skateboard deck 102 can facilitate a user to exchange a spent battery pack with a charged battery pack. A user may, therefore, be able to continue using the powered skateboard.

In variations where the skateboard deck 102 includes multiple apertures 172, 176, the aperture 176 for providing access to non-regularly removed components of the powered skateboard 100 may be covered by a lid 180. The lid 180 for covering aperture 176 can be secured such that the lid 180 is not easily removed, and may withstand a tumbling of the skateboard or any other shock. The lid 180 for covering aperture 176 can be secured to the top portion 110 of the skateboard deck 102 using screws, adhesive, and/or other securing methods.

The skateboard deck 102 can include one or more conduits 182. The one or more conduits 182 may be configured to facilitate connections between the power source and the motive source for the powered skateboard 100. The one or more conduits 182 can be configured to facilitate connections between an electrical power source disposed in the cavity 170 of the skateboard deck 102 and one or more electric motors disposed outside of the cavity 170 of the skateboard deck 102.

The components stored in the cavity 170 between the top portion 110 and the bottom portion 104 of the skateboard deck 102 may include a receiver, transmitter, and/or transceiver, herein referred to as a transceiver. The transceiver may be adapted to receive instructions from a user to control the powered skateboard 100. Instructions may be received from a transmitter. The transmitter may include a hand-held transmitter.

The skateboard deck 102 can include a port aperture 184. The port aperture 184 can be configured to secure an electronic port 186 into the skateboard deck 102. The electronic port 186 can be one or more of a USB port, a FireWire port, and/or other electronic port. The electronic port 186 can be configured to facilitate communications between an external device and one or more components of the powered skateboard 100. The electronic port 186 can be configured to facilitate transfer of electrical energy to one or more components of the powered skateboard 102. The electronic port 186 may be configured to facilitate transfer of electrical energy from one or more components of the powered skateboard to an external device.

The top portion 110 of the skateboard deck 102 may be secured to the bottom portion 104 of the skateboard deck 102. The top portion 110 of the skateboard deck 102 may be secured to the bottom portion 104 of the skateboard deck 102 by one or more of screws, adhesive, welding, mechanically fastening, and/or other securing mechanism. The top portion 110 of the skateboard deck 102 may be contiguous with the bottom portion 104 of the skateboard deck 102. The skateboard deck 102 may have a monocoque structure.

The skateboard deck 102 may comprise injection molded plastic. The skateboard deck 102 may comprise thermoplastic. The skateboard deck 102 may comprise carbon fiber. The skateboard deck 102 may comprise forged carbon fiber. The skateboard deck 102 may comprise pre-preg carbon fiber.

The components of the skateboard deck 102 may have a modular structure. The modular structure may have a polygonal structure. The polygonal structure may be hexagonal or rectangular. The polygonal structure may provide a lightweight structure while maintain strength and stability of the components of the skateboard deck 102.

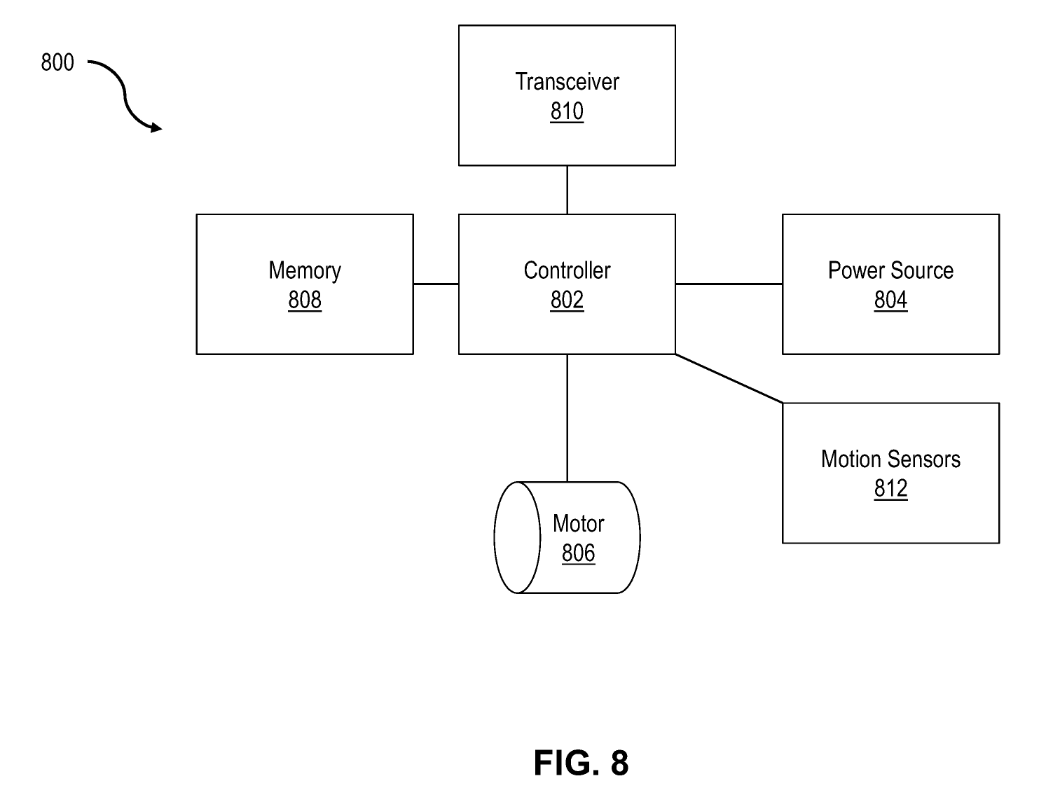

FIG. 8 is a schematic diagram of a control system 800 for a powered skateboard having one or more features consistent with the present description. The control system 800 can include a controller 802. The controller 802 can be configured to provide electricity, from the power source 804, to the motor 806. The motor 806 can be a hub motor disposed within a wheel of the skateboard. The motor 806 can be a brushless direct current hub motor contained substantially within a wheel of the skateboard. The wheel can be less than six inches in diameter.

The controller 802 can be configured to cause field weakening to increase the speed at which the motor 806 can rotate. The controller 802 can be configured to switch between different forms of motor control of the motor 806. For example, the controller 802 can be configured to cause trapezoidal commutation, sinusoidal commutation, and/or the like.

The controller 802 can be configured to advance the phase to which electricity is delivered using characteristic data associated with the motor 806.

As an example, the controller 802 can be configured to activate each phase of the motor 806 to cause a ninety-degree angle on the magnetic field. In an ordinary motor, for a given amount of current, delivered to the motor, the motor cannot be made to rotate faster. By advancing the phase at which electricity is delivered to the motor 806, an angle of the torque, relative to the motor, can be modified.

The amount of phase advance can be based on one or more characteristics of the motor 806. The one or more characteristics can include a speed of the motor, a position of the throttle on the controller, an amount of load on the motor, or the like. The one or more characteristics can be determined by a Hall effect sensor, for example. The controller 802 can be configured to determine a desirable duty cycle and phase angle. The controller 802 can be disposed within the skateboard. The throttle position can be transmitted from a handheld controller to the control system 800.

The control system 800 can include a transceiver 810 configured to communicate with an external device. In some variations, the control system 800 can include a receiver for receiving instructions from an external device. The external device can be a mobile computing device, a computer, a wireless base station (for example a Wi-Fi router, GSM base station, LTE base station, sub-GHz base station, or the like), a handheld controller for the powered skateboard, or the like. The transceiver 810 can be configured to receive updated control software from the external device. The updated control software can be stored on memory 808.

The control system 800 can be configured to facilitate activation and/or deactivation of features of the powered skateboard. For example, a user of the powered skateboard can set maximum speed, maximum acceleration, change a mode of the electric motor 806, or the like. The user can make such changes through an external device, a handheld controller, through an input on the skateboard, or the like.

The controller 802 can be configured to collect and store diagnostic information associated with the electric motor 806. For example, the controller 802 can be configured to generate and store a log of events on the memory 808. The log can include use information, error information, or the like. The controller 802 can be configured to collect and store diagnostic information associated with the power source 804 (for example a battery), the controller 802, and/or other components of the powered skateboard.

The transceiver 810 can be configured to facilitate transmission of data from the powered skateboard to an external device. Transmitted data can include diagnostic information stored in memory 806 of the powered skateboard. The diagnostic information can include an indication of user usage, motor performance, battery performance, or the like. Battery performance information can include charge and discharge information, or the like.

Modes of the powered skateboard that can be selected by the user can include eco mode, beginner mode, expert mote, or the like. An eco-mode can preserve battery life by preventing or avoiding use that would overly drain the battery. Beginner mode can cause the controller 802 to limit the speed and torque of the motor 806. Expert mode can provide an unrestricted speed and torque for the motor 806. The different modes can be selected through the handheld controller, through an external device in communication with the control system 800, or the like.

The control system 800 can include one or more sensors 812. The sensor(s) 812 can be configured to detect motion of the powered skateboard. Using sensor(s) 812, the controller 802 can be configured to detect sudden changes in acceleration of the powered skateboard that may indicate that the user of the powered skateboard is losing control. The controller 802 can be configured to take corrective action. Corrective action can include reducing the speed of the motor 806, increasing the speed of the 806, reversing the motor 806, or the like. When the powered skateboard is equipped with multiple motors, the controller 802 can be configured to independently control each motor 806. The controller 802 can take corrective action by causing different motors of the powered skateboard to behave in different ways. For example, if the controller 802 detects that one wheel is spinning, the controller 802 can be configured to reduce the power to the spinning wheel and increase the power to the non-spinning wheel.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An electrically powered vehicle, comprising:
one or more electrical motors configured to provide motive force for the electrically powered vehicle, the one or more electric motors comprising a plurality of phases;
a battery configured to provide electrical power to the one or more electric motors;
a controller configured to use software to control the one or more electric motors.

2. The electrically powered vehicle of claim 1, wherein the software is configured to control delivery of electrical power to one or more phases of the plurality of phases of the one or more electric motors.

3. The electrically powered vehicle of claim 2, wherein the controller is configured to deliver electricity to the plurality of phases to cause a ninety-degree angle on the magnetic field generated by the electric motor.

4. The electrically powered vehicle of claim 1, further comprising a memory configured to store the software.

5. The electrically powered vehicle of claim 4, further comprising a receiver configured to receive, over a wireless data connection, updated software to store in the memory, and wherein the controller is further configured to use the updated software to control the one or more electric motors.

6. The electrically powered vehicle of claim 1, wherein the software facilitates variable control of the one or more electric motors.

7. The electrically powered vehicle of claim 1, wherein the one or more electric motors further comprise a stator, the stator comprising a plurality of stator teeth.

8. The electrically powered vehicle of claim 7, wherein the one or more electric motors further comprise one or more sensors configured to determine, based on a voltage of the one or more sensors, positions of the plurality of stator teeth associated with different phases of the plurality of phases.

9. The electrically powered vehicle of claim 1, wherein the controller is further configured to advance a phase at which electricity is delivered to the one or more electric motors to modify an angle of torque relative to the motor.

10. The electrically powered vehicle of claim 9, wherein an amount of phase advance is based on a speed of the one or more electric motors, a position of a throttle on the controller, an amount of load on the one or more electric motors, a target duty cycle, and/or a target phase angle.

11. A method for powering an electrically powered vehicle, comprising:
storing, in memory, software for controlling one or more electric motors of a powered vehicle, the one or more electric motors comprising a plurality of phases; and
controlling, in response to executing the software on a controller of the powered vehicle, a delivery of electricity to the one or more electric motors.

12. The method of claim 11, wherein the software is configured to control delivery of electrical power to one or more phases of the plurality of phases of the one or more electric motors.

13. The method of claim 11, wherein controlling the delivery of electricity comprises delivering electricity to the plurality of phases to cause a ninety-degree angle on the magnetic field generated by the one or more electric motors.

14. The method of claim 11, further comprising:
receiving, over a wireless data connection, updated software to store in the memory; and
executing the updated software to control the one or more electric motors.

15. The method of claim 11, wherein controlling the delivery of electricity comprises variable control of the one or more electric motors.

16. The method of claim 11, wherein the one or more electric motors further comprise a stator, the stator comprising a plurality of stator teeth.

17. The method of claim 16, further comprising determining, based on a sensor, positions of the plurality of stator teeth associated with different phases of the plurality of phases.

18. The method of claim 11, wherein controlling the delivery of electricity comprises advancing a phase at which electricity is delivered to the one or more electric motors to modify an angle of torque relative to the motor.

19. The method of claim 18, wherein an amount of phase advance is based on a speed of the one or more electric motors, a position of a throttle on the controller, an amount of load on the one or more electric motors, a target duty cycle, and/or a target phase angle.

20. The method of claim 11, further comprising:
detecting motion of the electrically powered vehicle; and
adjusting, based on the detected motion, a speed of the one or more electric motors.
